(19) United States
(12) Patent Application Publication
(10) Pub. No.: US 2020/0350619 A1
(43) Pub. Date: Nov. 5, 2020

(54) LITHIUM-ION RECHARGEABLE BATTERY

(71) Applicant: SHOWA DENKO K.K., Tokyo (JP)

(72) Inventors: Takaki YASUDA, Ichihara-shi, Chiba (JP); Akira SAKAWAKI, Ichihara-shi, Chiba (JP); Haruaki UCHIDA, Ichihara-shi, Chiba (JP)

(73) Assignee: SHOWA DENKO K.K., Tokyo (JP)

(21) Appl. No.: 16/770,114

(22) PCT Filed: Nov. 26, 2018
(86) PCT No.: PCT/JP2018/043333

§ 371 Date: Jun. 5, 2020

(30) Foreign Application Priority Data
Dec. 22, 2017 (JP) 2017-246641

(51) Int. Cl. H01M 10/0562; H01M 10/0525; H01M 4/38; H01M 4/13

(52) U.S. Cl. CPC H01M 10/0562; H01M 10/0525; H01M 2004/028; H01M 4/13; H01M 4/38

(57) ABSTRACT

A lithium-ion rechargeable battery (1) includes: a positive electrode layer (30) containing a positive electrode active material; a solid electrolyte layer (40) containing an inorganic solid electrolyte; a storage layer (50) made of porous platinum (Pt) and storing lithium; a coating layer (60) made of an amorphous chromium-titanium (CrTi) alloy; and a negative electrode collector layer (70) made of platinum (Pt); these layers are stacked in this order. The storage layer (50) is first composed of a dense platinum layer formed by sputtering, and then undergoes initial charge and discharge to become porous, which results in a porous part (51) and a number of pores (52) being formed. This restrains or prevents peeling inside the all-solid lithium-ion rechargeable battery.

### TECHNICAL FIELD

The present invention relates to a lithium-ion rechargeable battery.

### BACKGROUND ART

With widespread use of portable electronics, such as mobile phones and laptop computers, a strong need exists for small and lightweight rechargeable batteries with a high energy density. Known examples of the rechargeable batteries meeting such a need include lithium-ion rechargeable batteries. The lithium-ion rechargeable battery includes a positive electrode containing a positive electrode active material, a negative electrode containing a negative electrode active material, and an electrolyte having lithium ion conductivity and disposed between the positive electrode and the negative electrode.

Conventional lithium-ion rechargeable batteries have used an organic electrolyte solution and the like as an electrolyte. Meanwhile, use has been proposed of a solid electrolyte made of an inorganic material (inorganic solid electrolyte) as an electrolyte, and use has also been proposed of a lithium excess layer excessively containing lithium metal and/or lithium as a negative electrode active material (see Patent Document 1). Patent Document 1 discloses stacking a positive electrode collector film, a positive electrode active material film, a solid electrolyte film, and a negative electrode collector film in this order and then producing a lithium excess layer between the solid electrolyte film and the negative electrode collector film by charging through the positive electrode collector film and the negative electrode collector film.

### CITATION LIST

### Patent Literature

Patent Document 1: Japanese Patent Application Laid-Open Publication No. 2013-164971

### SUMMARY OF INVENTION

### Technical Problem

Producing a lithium excess layer between a solid electrolyte film and a negative electrode collector film by charging has a drawback in that peeling may occur between the solid electrolyte film and the negative electrode collector film due to formation and disappearance of the lithium excess layer and, as a result, charge/discharge cycle life may shorten.

An object of the present invention is to prevent or restrain peeling inside an all-solid lithium-ion rechargeable battery.

### Solution to Problem

According to an aspect of the present invention, there is provided a lithium-ion rechargeable battery including, in the following order: a positive electrode layer containing a positive electrode active material; a solid electrolyte layer containing an inorganic solid electrolyte having lithium ion conductivity; and a porous noble metal layer having a porous structure and made of a platinum group element (Ru, Rh, Pd, Os, Ir, or Pt), gold (Au), or an alloy of some of the platinum group elements or at least one of the platinum group elements and the gold.

The above lithium-ion rechargeable battery may further include an amorphous metal layer stacked on the porous noble metal layer, the amorphous metal layer having an amorphous structure and being made of a metal or an alloy.

The amorphous metal layer may contain chromium (Cr).

The amorphous metal layer may be made of an alloy of chromium (Cr) and titanium (Ti).

The lithium-ion rechargeable battery may further include another noble metal layer stacked on the amorphous metal layer, the another noble metal layer being made of a platinum group element (Ru, Rh, Pd, Os, Ir, or Pt), gold (Au), or an alloy of some of the platinum group elements or at least one of the platinum group elements and the gold.

The inorganic solid electrolyte in the solid electrolyte layer may contain phosphate (PO₄³⁻).

### Advantageous Effects of Invention

The present invention prevents or restrains peeling inside an all-solid lithium-ion rechargeable battery.

### BRIEF DESCRIPTION OF DRAWINGS

FIG. 1 shows a sectional structure of a lithium-ion rechargeable battery of an embodiment.

FIG. 2 is a flowchart of a method for manufacturing the lithium-ion rechargeable battery of the embodiment.

FIG. 3 shows a sectional structure of the lithium-ion rechargeable battery of the embodiment after film deposition and before an initial charge.

FIGS. 4A to 4C explain a procedure for producing a porous storage layer.

FIG. 5A is a cross-sectional STEM picture of the lithium-ion rechargeable battery of the embodiment after the film deposition and before the initial charge. FIG. 5B is a cross-sectional STEM picture of the lithium-ion rechargeable battery of the embodiment after an initial discharge.

FIG. 6 shows a sectional structure of the lithium-ion rechargeable battery of a first modification.

FIG. 7 shows a sectional structure of the lithium-ion rechargeable battery of a second modification.

FIG. 8 shows a sectional structure of the lithium-ion rechargeable battery of a third modification.

FIG. 9 shows a sectional structure of the lithium-ion rechargeable battery of a fourth modification.

FIG. 10 is a cross-sectional STEM picture of the lithium-ion rechargeable battery of a comparative embodiment after an initial discharge.

### DESCRIPTION OF EMBODIMENTS

An embodiment of the present invention will be described in detail below with reference to the attached drawings. In the drawings as referred to in the below description, dimensions of each component, including size and thickness, may differ from actual ones.

### [Configuration of the Lithium-Ion Rechargeable Battery]

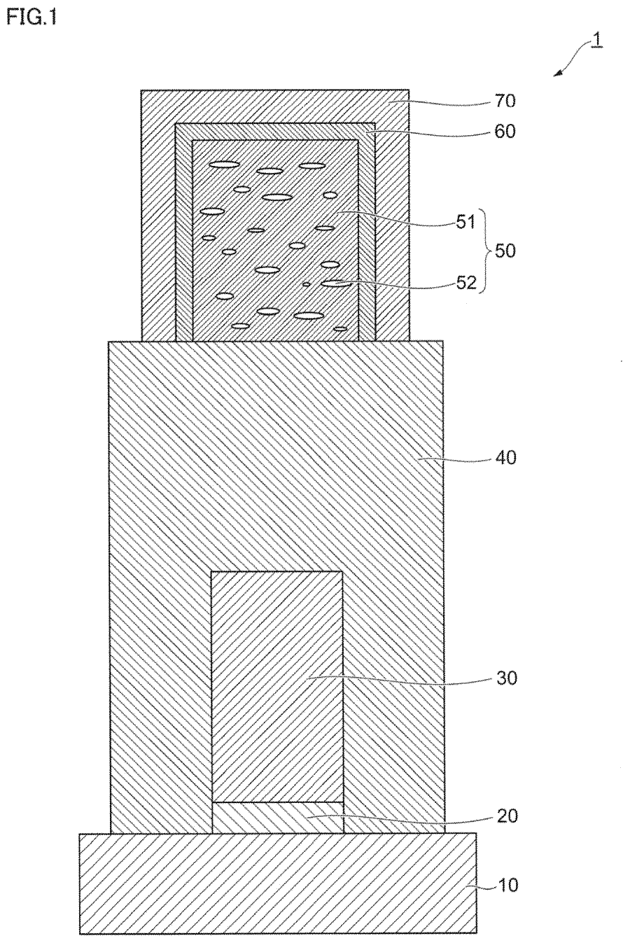

FIG. 1 shows a sectional structure of a lithium-ion rechargeable battery 1 of the present embodiment. As described later, the lithium-ion rechargeable battery 1 of the present embodiment has a multilayer structure composed of multiple layers (films); its basic structure is formed by a so-called film deposition process, and the structure is completed by an initial charging and discharging operations. FIG. 1 shows the lithium-ion rechargeable battery 1 after the initial discharge, namely after completion of its structure.

The lithium-ion rechargeable battery 1 shown in FIG. 1 includes: a substrate 10; a positive electrode collector layer 20 stacked on the substrate 10; a positive electrode layer 30 stacked on the positive electrode collector layer 20; a solid electrolyte layer 40 stacked on the positive electrode layer 30; and a storage layer 50 stacked on the solid electrolyte layer 40. The solid electrolyte layer 40 covers peripheries of both of the positive electrode collector layer 20 and the positive electrode layer 30, and an end of the solid electrolyte layer 40 is directly stacked on the substrate 10, whereby the solid electrolyte layer 40 covers the positive electrode collector layer 20 and the positive electrode layer 30 jointly with the substrate 10. The lithium-ion rechargeable battery 1 further includes a coating layer 60 stacked on the storage layer 50 and also directly stacked on the solid electrolyte layer 40 around the periphery of the storage layer 50 to coat the storage layer 50 jointly with the solid electrolyte layer 40. The lithium-ion rechargeable battery 1 further includes a negative electrode collector layer 70 stacked on the coating layer 60 and also directly stacked on the solid electrolyte layer 40 around the periphery of the coating layer 60 to cover the coating layer 60 jointly with the solid electrolyte layer 40.

The above constituents of the lithium-ion rechargeable battery 1 will be described in more detail below.

### (Substrate)

The substrate 10 is not limited to a particular material, and may be made of any of various materials including metal, glass, and ceramics.

In the present embodiment, the substrate 10 is composed of a metal plate having electronic conductivity. More specifically, in the present embodiment, stainless steel foil (plate), which has higher mechanical strength than copper, aluminum and the like, is used as the substrate 10. Alternatively, metallic foil obtained by plating with conductive metals, such as tin, copper and chrome, may be used as the substrate 10.

The substrate 10 may have a thickness of 20 μm or more and 2000 μm or less, for example. A thickness of less than 20 μm may lead to insufficient strength of the lithium-ion rechargeable battery 1. Meanwhile, a thickness of more than 2000 μm leads to reduced volume energy density and weight energy density due to increase in battery weight and thickness.

### (Positive Electrode Collector Layer)

The positive electrode collector layer 20 may be a solid thin film having electronic conductivity. As long as these conditions are met, the positive electrode collector layer 20 is not limited to a particular material and may be made of, for example, any conductive material including various metals and alloys of metals.

The positive electrode collector layer 20 may have a thickness of 5 nm or more and 50 μm or less, for example. With a thickness of less than 5 nm, the positive electrode collector layer 20 has reduced current collection capability, which makes the lithium-ion rechargeable battery 1 impracticable. Meanwhile, when the positive electrode collector layer 20 has a thickness of more than 50 μm, it increases internal resistance of the battery, which is disadvantageous for high speed charging/discharging.

While any known deposition method may be used to manufacture the positive electrode collector layer 20, such as various physical vapor deposition (PVD) and chemical vapor deposition (CVD) methods, it is preferable to use a sputtering method or a vacuum deposition method in terms of production efficiency.

When the substrate 10 is made of a conductive material such as a metal plate, there is no need to provide the positive electrode collector layer 20 between the substrate 10 and the positive electrode layer 30. When the substrate 10 is made of an insulating material, it is preferable to provide the positive electrode collector layer 20 between the substrate 10 and the positive electrode layer 30.

### (Positive Electrode Layer)

The positive electrode layer 30 is a solid thin film and contains a positive electrode active material that releases lithium ions during a charge and occludes lithium ions during a discharge. The positive electrode active material constituting the positive electrode layer 30 may be any of various materials such as oxides, sulfides or phosphorus oxides containing at least one kind of metals selected from manganese (Mn), cobalt (Co), nickel (Ni), iron (Fe), molybdenum (Mo), and vanadium (V). Alternatively, the positive electrode layer 30 may be made of a positive electrode mixture containing a solid electrolyte.

The positive electrode layer 30 may have a thickness of 10 nm or more and 40 μm or less, for example. With the positive electrode layer 30 having a thickness of less than 10 nm, the lithium-ion rechargeable battery 1 obtained therefrom has a too small capacity, which makes the lithium-ion rechargeable battery 1 impracticable. Meanwhile, with the positive electrode layer 30 having a thickness of more than 40 μm, it takes too much time to form the layer, which reduces productivity. The positive electrode layer 30 may, however, have a thickness of more than 40 μm when a large battery capacity is required of the lithium-ion rechargeable battery 1.

While any known deposition method may be used to fabricate the positive electrode layer 30, such as various PVD and CVD methods, it is preferable to use a sputtering method in terms of production efficiency.

### (Solid Electrolyte Layer)

The solid electrolyte layer 40 is a solid thin film and contains a solid electrolyte made of an inorganic material (inorganic solid electrolyte). The inorganic solid electrolyte constituting the solid electrolyte layer 40 is not limited to a particular material as long as the inorganic solid electrolyte has lithium ion conductivity, and may be made of any of various materials including oxides, nitrides, and sulfides. In terms of increasing lithium ion conductivity, the inorganic solid electrolyte constituting the solid electrolyte layer 40 preferably contains phosphate (PO₄³⁻).

The solid electrolyte layer 40 may have a thickness of 10 nm or more and 10 μm or less, for example. With the solid electrolyte layer 40 having a thickness of less than 10 nm, the lithium-ion rechargeable battery 1 obtained therefrom is prone to a short circuit (leakage) between the positive electrode layer 30 and the storage layer 50. Meanwhile, when the solid electrolyte layer 40 has a thickness of more than 10 μm, it increases internal resistance of the battery, which is disadvantageous for high speed charging/discharging.

While any known deposition method may be used to manufacture the solid electrolyte layer 40, such as various PVD and CVD methods, it is preferable to use a sputtering method in terms of production efficiency.

### (Storage Layer)

The storage layer 50 is a solid thin film and has a function to store lithium ions.

The storage layer 50 shown in FIG. 1 includes a porous part 51 with a number of pores 52. That is, the storage layer 50 of the present embodiment has a porous structure. This porous storage layer 50, or the porous part 51, is formed by initial charging and discharging operations after film deposition, which will be described in detail later.

The storage layer 50 (the porous part 51) may be made of a platinum group element (Ru, Rh, Pd, Os, Ir, Pt), gold (Au), or an alloy of some of these metals. Among these, the storage layer 50 is preferably composed of platinum (Pt) or gold (Au), which are less prone to oxidation. The storage layer 50 (the porous part 51) may be a polycrystal of any of the above noble metals or an alloy of some of these metals.

The storage layer 50 may have a thickness of 10 nm or more and 40 μm or less, for example. With a thickness of less than 10 nm, the storage layer 50 lacks sufficient capacity to store lithium. Meanwhile, when the storage layer 50 has a thickness of more than 40 μm, it increases internal resistance of the battery, which is disadvantageous for high speed charging/discharging. The storage layer 50 may, however, have a thickness of more than 40 μm when a large battery capacity is required of the lithium-ion rechargeable battery 1.

While any known deposition method may be used to manufacture the storage layer 50, such as various PVD and CVD methods, it is preferable to use a sputtering method in terms of production efficiency. Making the storage layer 50 porous is preferably done by charging and discharging, as described later.

### (Coating Layer)

The coating layer 60, which is an example of the amorphous metal layer, is a solid thin film made of any metal or alloy having an amorphous structure. Among these, in terms of corrosion resistance, the coating layer 60 is preferably made of a simple substance of chromium (Cr) or an alloy containing chromium, and more preferably made of an alloy of chromium and titanium (Ti). Also, the coating layer 60 is preferably made of any metal or alloy that does not form an intermetallic compound with lithium (Li). The coating layer 60 may also be composed of a stack of multiple amorphous layers made of different materials (e.g., a stack of an amorphous chromium layer and an amorphous chromium-titanium alloy layer).

The term “amorphous structure” as referred to in the present embodiment not only means an entirely amorphous structure but also means an amorphous structure in which microcrystals are deposited.

The coating layer 60 may have a thickness of 10 nm or more and 40 μm or less, for example. With a thickness of less than 10 nm, the coating layer 60 may hardly block lithium having passed through the storage layer 50 from the solid electrolyte layer 40 side. Meanwhile, when the coating layer 60 has a thickness of more than 40 μm, it increases internal resistance of the battery, which is disadvantageous for high speed charging/discharging.

While any known deposition method may be used to manufacture the coating layer 60, such as various PVD and CVD methods, it is preferable to use a sputtering method in terms of production efficiency. In particular, when the coating layer 60 is made of the above chromium-titanium alloy, use of a sputtering method facilitates amorphization of the chromium-titanium alloy.

Examples of metals (alloys) that can be used for the coating layer 60 include ZrCuAlNiPdP, CuZr, FeZr, TiZr, CoZrNB, NiNb, NiTiNb, NiP, CuP, NiPCu, NiTi, CrTi, AlTi, FeSiB, and AuSi.

### (Negative Electrode Collector Layer)

The negative electrode collector layer 70, which is an example of another noble metal layer, may be a solid thin film having electronic conductivity. As long as these conditions are met, the negative electrode collector layer 70 is not limited to a particular material and may be made of, for example, any conductive material including various metals and alloys of metals. In terms of preventing corrosion of the coating layer 60, a chemically stable material is preferably used for the negative electrode collector layer 70; for example, the negative electrode collector layer 70 is preferably made of a platinum group element (Ru, Rh, Pd, Os, Ir, Pt), gold (Au), or an alloy of some of these metals.

The negative electrode collector layer 70 may have a thickness of 5 nm or more and 50 μm or less, for example. A thickness of less than 5 nm leads to reduced corrosion resistance and current collecting function of the negative electrode collector layer 70, which makes the lithium-ion rechargeable battery 1 impracticable. Meanwhile, when the negative electrode collector layer 70 has a thickness of more than 50 μm, it increases internal resistance of the battery, which is disadvantageous for high speed charging/discharging.

While any known deposition method may be used to manufacture the negative electrode collector layer 70, such as various PVD and CVD methods, it is preferable to use a sputtering method in terms of production efficiency.

### (Relationship Between the Positive Electrode Layer and the Storage Layer)

In the lithium-ion rechargeable battery 1, the positive electrode layer 30 and the storage layer 50 face each other across the solid electrolyte layer 40. That is, the positive electrode layer 30 containing a positive electrode active material is positioned on the opposite side of the solid electrolyte layer 40 from the storage layer 50. When viewed from above in FIG. 1, the plane size of the storage layer 50 is larger than that of the positive electrode layer 30. Also, when viewed from above in FIG. 1, the entire periphery of the plane of the positive electrode layer 30 is positioned within the entire periphery of the plane of the storage layer 50. Thus, a top face (plane) of the positive electrode layer 30 shown in FIG. 1 is faced with a bottom face (plane) of the storage layer 50 across the solid electrolyte layer 40.

### [Method for Manufacturing the Lithium-Ion Rechargeable Battery]

Below a description will be given of a method for manufacturing the above lithium-ion rechargeable battery 1.

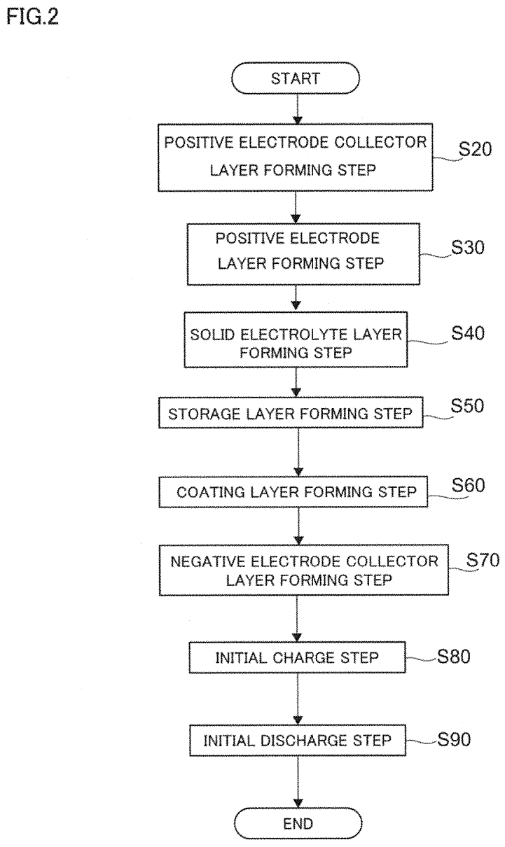

FIG. 2 is a flowchart of a method for manufacturing the lithium-ion rechargeable battery 1 of the present embodiment.

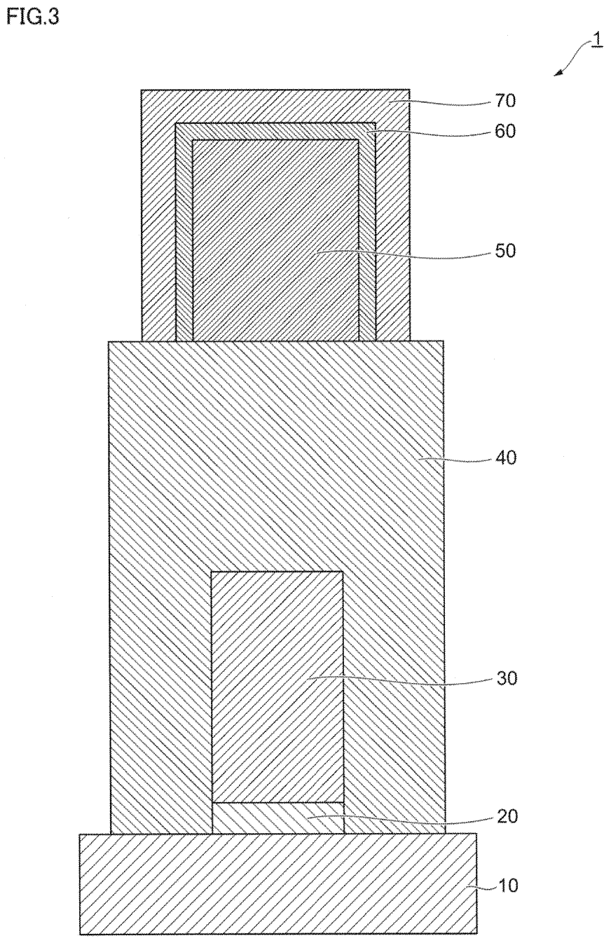

First, a positive electrode collector layer forming step is performed where the substrate 10 is mounted on a sputtering device (not shown) and the positive electrode collector layer 20 is formed on the substrate 10 (step 20). Then, a positive electrode layer forming step is performed where the positive electrode layer 30 is formed on the positive electrode collector layer 20 by the sputtering device (step 30). Then, a solid electrolyte layer forming step is performed where the solid electrolyte layer 40 is formed on the positive electrode layer 30 by the sputtering device (step 40). A storage layer forming step is then performed where the storage layer 50 is formed on the solid electrolyte layer 40 by the sputtering device (step 50). A coating layer forming step is performed where the coating layer 60 is formed on the solid electrolyte layer 40 and the storage layer 50 by the sputtering device (step 60). Then, a negative electrode collector layer forming step is performed where the negative electrode collector layer 70 is formed on the solid electrolyte layer 40 and the coating layer 60 (step 70). Executing these steps 20 to 70 results in the lithium-ion rechargeable battery 1 after film deposition (and before an initial charge) as shown in FIG. 3 described later. This lithium-ion rechargeable battery 1 is removed from the sputtering device.

Then, an initial charge step is performed where the lithium-ion rechargeable battery 1 removed from the sputtering device is given an initial charge (step 80). In step 80, a positive electrode terminal and a negative electrode terminal are connected to the substrate 10 and the negative electrode collector layer 70, respectively, of the lithium-ion rechargeable battery 1, and the lithium-ion rechargeable battery 1 is charged through these positive and negative electrode terminals. Subsequently, an initial discharge step is performed where the charged lithium-ion rechargeable battery 1 performs an initial discharge (step 90). Discharging of the lithium-ion rechargeable battery 1 can be done through the above positive and negative electrode terminals. Through these initial charge and discharge, the storage layer 50 becomes porous, or the porous part 51 and a number of pores 52 are formed, resulting in the lithium-ion rechargeable battery 1 shown in FIG. 1. The porous storage layer 50 produced by the initial charge and discharge will be detailed later.

[Configuration of the Lithium-Ion Rechargeable Battery after the Film Deposition and Before the Initial Charge]

FIG. 3 shows a sectional structure of the lithium-ion rechargeable battery 1 of the present embodiment after the film deposition and before the initial charge. FIG. 3 shows the lithium-ion rechargeable battery 1 when steps 20 to 70 shown in FIG. 2 have been completed. FIG. 1 shows the lithium-ion rechargeable battery 1 after completion of step 90 (i.e. all steps) shown in FIG. 2.

The basic structure of the lithium-ion rechargeable battery 1 shown in FIG. 3 is the same as that of the lithium-ion rechargeable battery 1 shown in FIG. 1, except that the storage layer 50 of the lithium-ion rechargeable battery 1 shown in FIG. 3 is not porous but denser than the storage layer 50 shown in FIG. 1. Additionally, the lithium-ion rechargeable battery 1 shown in FIG. 3 differs from the lithium-ion rechargeable battery 1 shown in FIG. 1 in that the thickness of the storage layer 50 shown in FIG. 3 is smaller than that of the storage layer 50 shown in FIG. 1.

### [Production of the Porous Storage Layer]

Below a detailed description will be given of production of the above porous storage layer 50.

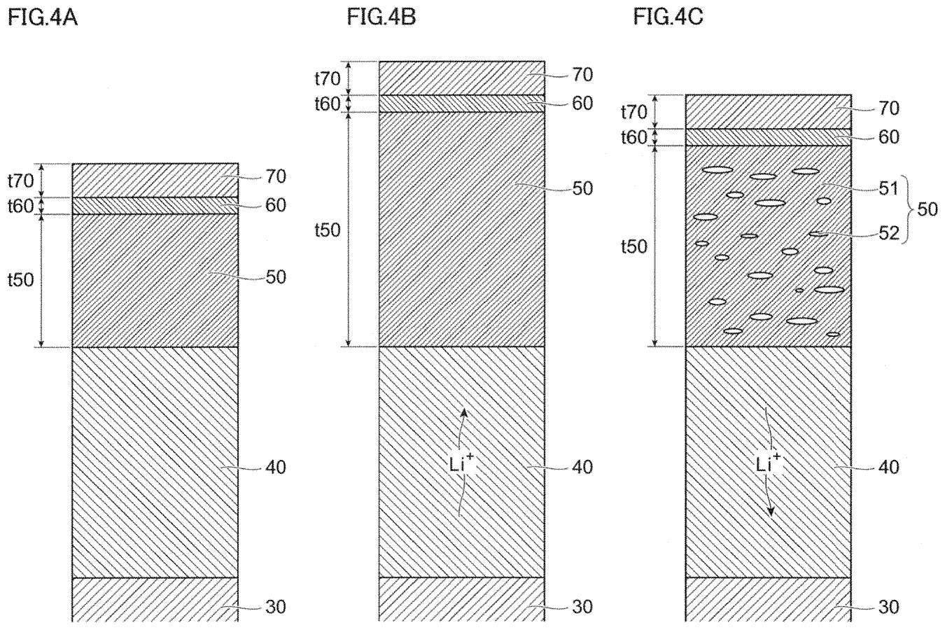

FIGS. 4A to 4C are enlarged views of the storage layer 50 and its nearby layers for explaining a procedure for producing the porous storage layer 50. FIG. 4A shows the state after the film deposition and before the initial charge (i.e. after step 70), FIG. 4B shows the state after the initial charge and before the initial discharge (i.e. the state between step 80 and step 90), and FIG. 4C shows the state after the initial discharge (i.e. after step 90). Thus, FIG. 4A corresponds to FIG. 3, and FIG. 4C corresponds to FIG. 1. The storage layer 50 before becoming porous shown in FIG. 4A is an example of the noble metal layer, and the storage layer 50 after becoming porous shown in FIG. 4C is an example of the porous noble metal layer.

### (After the Film Deposition and Before the Initial Charge)

In the state after the film deposition and before the initial charge shown in FIG. 4A, the storage layer 50 is dense. The storage layer 50 has a storage layer thickness t50, the coating layer 60 has a coating layer thickness t60, and the negative electrode collector layer 70 has a negative electrode collector layer thickness t70.

### (After the Initial Charge and Before the Initial Discharge)

When the lithium-ion rechargeable battery 1 shown in FIG. 4A is charged (initially charged), a positive electrode of a DC power source is connected to the substrate 10 (see FIG. 1), and a negative electrode of the DC power source is connected to the negative electrode collector layer 70. This causes lithium ions (Lit) constituting the positive electrode active material in the positive electrode layer 30 to move through the solid electrolyte layer 40 to the storage layer 50, as shown in FIG. 4B. In other words, in the charging operation, lithium ions move in the thickness direction (in the upward direction in FIG. 4B) of the lithium-ion rechargeable battery 1.

At this time, the lithium ions having moved from the positive electrode layer 30 to the storage layer 50 are alloyed with the noble metal constituting the storage layer 50. For example, when the storage layer 50 is made of platinum (Pt), lithium is alloyed with platinum in the storage layer 50 (formation of a solid solution, formation of an intermetallic compound, or formation of a eutectic).

Also, some of lithium ions having entered the storage layer 50 pass therethrough to reach a boundary between the storage layer 50 and the coating layer 60. The coating layer 60 of the present embodiment is made of a metal or alloy having an amorphous structure and thus includes the significantly smaller number of grain boundaries than the storage layer 50, which has a polycrystalline structure. For this reason, the lithium ions having reached the boundary between the storage layer 50 and the coating layer 60 hardly enter the coating layer 60, and they remain stored within the storage layer 50.

After completion of the initial charge, the lithium ions having moved from the positive electrode layer 30 to the storage layer 50 are stored within the storage layer 50. The reason why the lithium ions having moved to the storage layer 50 are stored within the storage layer 50 is likely to be because the lithium ions are alloyed with platinum or metallic lithium is deposited in platinum.

As shown in FIG. 4B, after the initial charge and before the initial discharge of the lithium-ion rechargeable battery 1, the storage layer thickness t50 increases from its thickness after the film deposition and before the initial charge shown in FIG. 4A. In other words, the volume of the storage layer 50 is increased by the initial charge. This is likely to be because of alloying of lithium and platinum in the storage layer 50. On the other hand, the coating layer thickness t60 changes little before and after the initial charge. In other words, the volume of the coating layer 60 is changed little by the initial charge. This is likely to be because lithium hardly enters the coating layer 60. This assumption can be backed by the fact that the negative electrode collector layer thickness t70 changes little before and after the initial charge, or in other words, the volume of the negative electrode collector layer 70 changes little before and after the initial charge (platinum constituting the negative electrode collector layer 70 is not made porous, unlike platinum constituting the storage layer 50, and remains dense).

### (After the Initial Discharge)

When the lithium-ion rechargeable battery 1 shown in FIG. 4B is discharged (initially discharged), a positive side of a load is connected to the substrate 10 (see FIG. 1) and a negative side of the load is connected to the negative electrode collector layer 70. This causes lithium ions (Lit) stored in the storage layer 50 to move through the solid electrolyte layer 40 to the positive electrode layer 30, as shown in FIG. 4C. In other words, in the discharging operation, lithium ions move in the thickness direction (the downward direction in FIG. 4C) of the lithium-ion rechargeable battery 1 to be stored in the positive electrode layer 30. Along with this, a direct current is supplied to the load.

At this time, dealloying of the lithium-platinum alloy (when metal lithium is deposited in platinum, solubilization of metal lithium) takes place in the storage layer 50 as lithium leaves the storage layer 50. As a result of the dealloying in the storage layer 50, the storage layer 50 becomes porous, resulting in the porous part 51 with a number of pores 52. The thus-obtained porous part 51 is composed almost entirely of a noble metal (e.g., platinum). After completion of the initial discharge, however, lithium does not disappear in the storage layer 50 but some lithium that does not move during the discharging operation remains in the storage layer 50.

As shown in FIG. 4C, after the initial discharge of the lithium-ion rechargeable battery 1, the storage layer thickness t50 decreases from its thickness after the initial charge and before the initial discharge shown in FIG. 4B. This is likely to be because of the dealloying of the lithium-platinum alloy in the storage layer 50. This assumption can be backed by the fact that the shape of each pore 52 formed in the storage layer 50 by the initial discharge is flattened such that its length in the thickness direction is shorter than its length in the plane direction. Also, as shown in FIG. 4C, after the initial discharge of the lithium-ion rechargeable battery 1, the storage layer thickness t50 increases from its thickness after the film deposition and before the initial charge shown in FIG. 4A. This is likely to be because the storage layer 50 is made porous, or in other words, a large number of pores 52 are formed in the storage layer 50, by the initial charge and discharge. On the other hand, the coating layer thickness t60 and the negative electrode collector layer thickness t70 change little before and after the initial discharge.

### Exemplary Configuration of the Lithium-Ion Rechargeable Battery 1 of the Present Embodiment

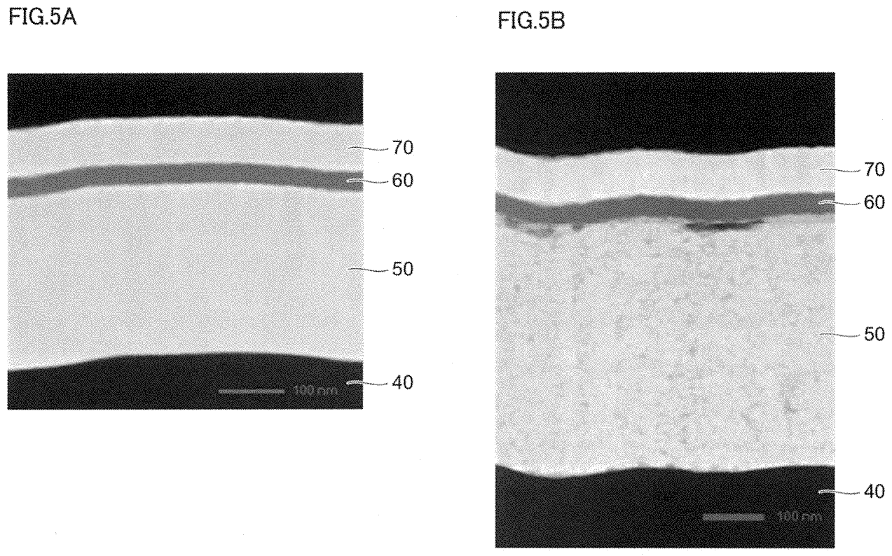

FIGS. 5A and 5B are cross-sectional scanning transmission electron microscope (STEM) pictures of the lithium-ion rechargeable battery 1 of the present embodiment; FIG. 5A shows a STEM picture of the lithium-ion rechargeable battery 1 after the film deposition and before the initial charge, and FIG. 5B shows a STEM picture of the lithium-ion rechargeable battery 1 after the initial discharge. These STEM pictures were taken by Ultra-thin Film Evaluation System HD-2300 from Hitachi High-Technologies Corporation. FIG. 5A corresponds to FIG. 4A (and FIG. 3), and FIG. 5B corresponds to FIG. 4C (and FIG. 1).

The specific configuration and manufacturing method of the lithium-ion rechargeable battery 1 shown in FIG. 5A are as follows.

Stainless steel (SUS304) was used as the substrate 10 (omitted in FIG. 5A). The substrate 10 was 30 μm thick.

Aluminum (Al) formed by sputtering was used as the positive electrode collector layer 20 (omitted in FIG. 5A). The positive electrode collector layer 20 was 100 nm thick.

Lithium manganate (Li_{1.5}Mn₂O₄) formed by sputtering was used as the positive electrode layer 30 (omitted in FIG. 5A). The positive electrode layer 30 was 1000 nm thick.

LiPON (obtained by displacing a part of oxygen in lithium phosphate (Li₃PO₄) with nitrogen) formed by sputtering was used as the solid electrolyte layer 40. The solid electrolyte layer 40 was 1000 nm thick.

Platinum (Pt) formed by sputtering was used as the storage layer 50. The storage layer 50 was 410 nm thick (after the film deposition and before the initial charge).

Chromium-titanium alloy (CrTi) formed by sputtering was used as the coating layer 60. The coating layer 60 was 50 nm thick.

Platinum (Pt) formed by sputtering was used as the negative electrode collector layer 70. The negative electrode collector layer 70 was 100 nm thick.

The thus-obtained lithium-ion rechargeable battery 1 after the film deposition and before the initial charge (see FIG. 3) was subjected to electron diffraction for analysis of its crystal structure. The results were as follows.

The substrate 10 made of SUS304, the positive electrode collector layer 20 made of aluminum, and the storage layer 50 and the negative electrode collector layer 70 made of platinum were crystalized. On the other hand, the positive electrode layer 30 made of lithium manganate, the solid electrolyte layer 40 made of LiPON, and the coating layer 60 made of chromium-titanium alloy were amorphous. However, rings were slightly observed in the electron diffraction patterns of the positive electrode layer 30, the solid electrolyte layer 40, and the coating layer 60; they were found to contain microcrystals in the amorphous structure.

The thus-obtained lithium-ion rechargeable battery 1 was subjected to the initial charge and the initial discharge.

### Initial Charge Conditions

Current: 1C

End voltage: 4.0V or 2 hours

### Initial Discharge Conditions

Current: 1C

End voltage: 2.0V

The STEM pictures shown in FIGS. 5A and 5B will be described below.

In FIG. 5A, the storage layer 50 is almost uniformly white, whereas in FIG. 5B, multiple gray spots are present on the white background. In FIG. 5B, some gray spots in the storage layer 50 near the boundary between the storage layer 50 and the coating layer 60 are flattened with a shorter length in the thickness direction than a length in the plane direction and are relatively larger than other gray spots in the storage layer 50. In FIG. 5B, the white background portion is considered as corresponding to the porous part 51, and the gray portions are considered as corresponding to the pores 52. In FIG. 5B, the storage layer 50 is thicker than the storage layer 50 shown in FIG. 5A. The storage layer 50 shown in FIG. 5B was 610 nm thick (after the initial discharge).

Both of the coating layer 60 and the negative electrode collector layer 70 have little change in gray level between the pictures of FIGS. 5A and 5B. Further, both of the coating layer 60 and the negative electrode collector layer 70 have little change in thickness between the pictures of FIGS. 5A and 5B.

### Exemplary Configuration of a Lithium-Ion Rechargeable Battery of a Comparative Embodiment

For comparison with the lithium-ion rechargeable battery 1 of the present embodiment, the present inventors fabricated a lithium-ion rechargeable battery with a different layer structure (hereinafter referred to as a “lithium-ion rechargeable battery of a comparative embodiment”).

Table 1 shows layer materials of the lithium-ion rechargeable battery 1 of the present embodiment and the lithium-ion rechargeable battery of the comparative embodiment.

TABLE 1

| | PRESENT | COMPARATIVE |
|---|---|---|
| | EMBODIMENT | EMBODIMENT |
| SUBSTRATE 10 | STAINLESS | STAINLESS |
| | STEEL (SUS304) | STEEL (SUS304) |
| POSITIVE ELECTRODE | ALUMINUM (Al) | TITANIUM (Ti) |
| COLLECTOR LAYER 20 | | |
| POSITIVE | Li_{1.5}Mn₂O₄ | Li_{1.5}Mn₂O₄ |
| ELECTRODE LAYER 30 | | |
| SOLID ELECTROLYTE | LiPON | LiPON |
| LAYER 40 | | |
| STORAGE LAYER 50 | PLATINUM (Pt) | NONE |
| COATING LAYER 60 | CHROMIUM- | NONE |
| | TITANIUM | |
| | ALLOY (CrTi) | |
| NEGATIVE ELECTRODE | PLATINUM (Pt) | COPPER (Cu)/ |
| COLLECTOR LAYER 70 | | TITANIUM (Ti) |

The specific configuration and manufacturing method of the lithium-ion rechargeable battery of the comparative embodiment are as follows.

Stainless steel (SUS304) was used as the substrate 10 (omitted in FIG. 5A). The substrate 10 was 30 μm thick.

Titanium (Ti) formed by sputtering was used as the positive electrode collector layer 20. The positive electrode collector layer 20 was 300 nm thick.

Lithium manganate (Li_{1.5}Mn₂O₄) formed by sputtering was used as the positive electrode layer 30 (omitted in FIG. 5A). The positive electrode layer 30 was 550 nm thick.

LiPON (obtained by displacing a part of oxygen in lithium phosphate (Li₃PO₄) with nitrogen) formed by sputtering was used as the solid electrolyte layer 40. The solid electrolyte layer 40 was 550 nm thick.

The negative electrode collector layer 70 was composed of two layers of a first negative electrode collector layer 71 and a second negative electrode collector layer 72. The first negative electrode collector layer 71 was made of copper (Cu) formed by sputtering and was 450 nm thick (after the film deposition and before the initial charge). The second negative electrode collector layer 72 was made of titanium (Ti) formed by sputtering and was 1000 nm thick. The storage layer 50 and the coating layer 60 were not formed.

The thus-obtained lithium-ion rechargeable battery was subjected to the initial charge and discharge under the above initial charge and discharge conditions.

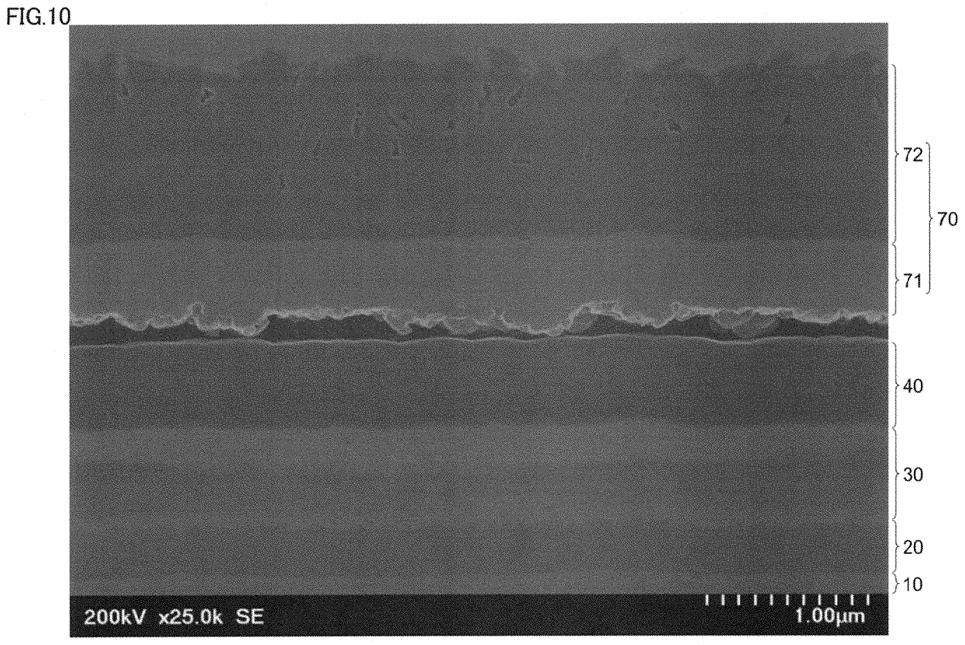

FIG. 10 is a cross-sectional STEM picture of the lithium-ion rechargeable battery of the comparative embodiment after the initial discharge. This STEM picture was also taken by Ultra-thin Film Evaluation System HD-2300 from Hitachi High-Technologies Corporation.

FIG. 10 shows that, after the initial discharge, a gap (crack) is formed at the boundary between the solid electrolyte layer 40 and the copper first negative electrode collector layer 71 along their interface. Additionally, in the lithium-ion rechargeable battery of the comparative embodiment, the first negative electrode collector layer 71 after the initial discharge has an almost uniform gray level distribution, which means that the first negative electrode collector layer 71 is not made porous (not formed with pores). The first negative electrode collector layer 71 of the lithium-ion rechargeable battery of the comparative embodiment had little changes in thickness before and after the initial charge and discharge.

Reasons for formation of the gap (crack) at the boundary between the solid electrolyte layer 40 and the copper first negative electrode collector layer 71 in the lithium-ion rechargeable battery of the comparative embodiment are considered as follows.

When the lithium-ion rechargeable battery of the comparative embodiment is charged, lithium ions having moved from the positive electrode layer 30 through the solid electrolyte layer 40 toward the first negative electrode collector layer 71 do not enter the inside of the first negative electrode collector layer 71 but are deposited at the boundary between the solid electrolyte layer 40 and the first negative electrode collector layer 71, forming a negative electrode layer (or a lithium excess layer). Hence, it is conceivable that, in the lithium-ion rechargeable battery of the comparative embodiment, lithium ions having moved from the positive electrode layer 30 toward the first negative electrode collector layer 71 are hardly alloyed with copper constituting the first negative electrode collector layer 71.

When the charged lithium-ion rechargeable battery of the comparative embodiment is discharged, lithium ions present in the negative electrode layer formed at the boundary between the solid electrolyte layer 40 and the first negative electrode collector layer 71 move through the solid electrolyte layer 40 to the positive electrode layer 30. Once the negative electrode layer almost disappears due to many lithium ions leaving the negative electrode layer along with the discharge, the solid electrolyte layer 40 and the copper first negative electrode collector layer 71 cannot re-adhere to each other. This is considered to be a cause of formation of the gap (crack) at the boundary between the solid electrolyte layer 40 and the first negative electrode collector layer 71 in the discharged lithium-ion rechargeable battery of the comparative embodiment.

Hence, in the lithium-ion rechargeable battery of the comparative embodiment, the first negative electrode collector layer 71 made of copper, which is not a noble metal, actually has little functionality to store lithium ions and maintain adhesion between the first negative electrode collector layer 71 and the solid electrolyte layer 40. This assumption can be backed by the fact that the copper first negative electrode collector layer 71 of the lithium-ion rechargeable battery of the comparative embodiment is not made porous after the initial discharge, as shown in FIG. 10.

### CONCLUSION

As described above, the lithium-ion rechargeable battery 1 of the present embodiment includes the porous storage layer 50 made of platinum on the solid electrolyte layer 40. This restrains peeling inside the lithium-ion rechargeable battery 1 that may be caused by deposition of lithium due to charging, as compared to, for example, when a negative electrode layer made of lithium is disposed between the solid electrolyte layer 40 and the negative electrode collector layer 70.

In the present embodiment, the coating layer 60 made of a chromium-titanium alloy having an amorphous structure is stacked on the storage layer 50 facing the positive electrode layer 30 across the solid electrolyte layer 40. This restrains lithium having moved from the positive electrode layer 30 to the storage layer 50 during the charging operation from leaking outside through the coating layer 60, as compared to, for example, when the coating layer 60 having a polycrystalline structure is stacked on the storage layer 50.

In the present embodiment, the negative electrode collector layer 70 made of platinum is disposed on the coating layer 60. This restrains corrosion (deterioration) of the metals (chromium and titanium) constituting the coating layer 60 that may be caused by oxidation and the like, as compared to, for example, when the negative electrode collector layer 70 made of a material other than noble metals is disposed on the coating layer 60.

In the present embodiment, LiPON containing phosphate (PO₄³⁻) is used as the inorganic solid electrolyte constituting the solid electrolyte layer 40, and using a porous noble metal layer made of platinum and the like as the storage layer 50 helps restrain corrosion of the storage layer 50 that may otherwise be caused by the phosphate.

Though detailed description is not given here, when the storage layer 50 is made of any platinum group element (Ru, Rh, Pd, Os, Ir, Pt), gold (Au), or an alloy of some of these metals, the storage layer 50 can be made porous by charging and discharging and store lithium therein, similarly to the storage layer 50 solely composed of platinum (Pt).

In manufacturing the lithium-ion rechargeable battery 1 of the present embodiment, its basic structure is formed by a so-called film deposition process, and then the structure is completed by the initial charging and discharging operations. More specifically, the dense storage layer 50 is formed by a film deposition process such as sputtering, and then the storage layer 50 is made porous by the initial charging operation and the initial discharging operation. This allows for a simple manufacturing process for the lithium-ion rechargeable battery, as compared to, for example, when the storage layer 50 is made porous by another separate process.

Further, in the lithium-ion rechargeable battery 1 of the present embodiment, the plane size of the storage layer 50 is larger than that of the positive electrode layer 30, which faces the storage layer 50 across the solid electrolyte layer 40. This restrains lithium ions from moving in a lateral direction (plane direction) when the lithium ions move from the positive electrode layer 30 to the storage layer 50. This, in turn, restrains outside leakage of lithium ions from sides of the lithium-ion rechargeable battery 1.

### [Modifications]

In the lithium-ion rechargeable battery 1 of the present embodiment, the substrate 10 and the solid electrolyte layer 40 cover the positive electrode collector layer 20 and the positive electrode layer 30, and the solid electrolyte layer 40, the coating layer 60, and the negative electrode collector layer 70 cover the storage layer 50. The present invention is, however, not limited to this configuration.

### (First Modification)

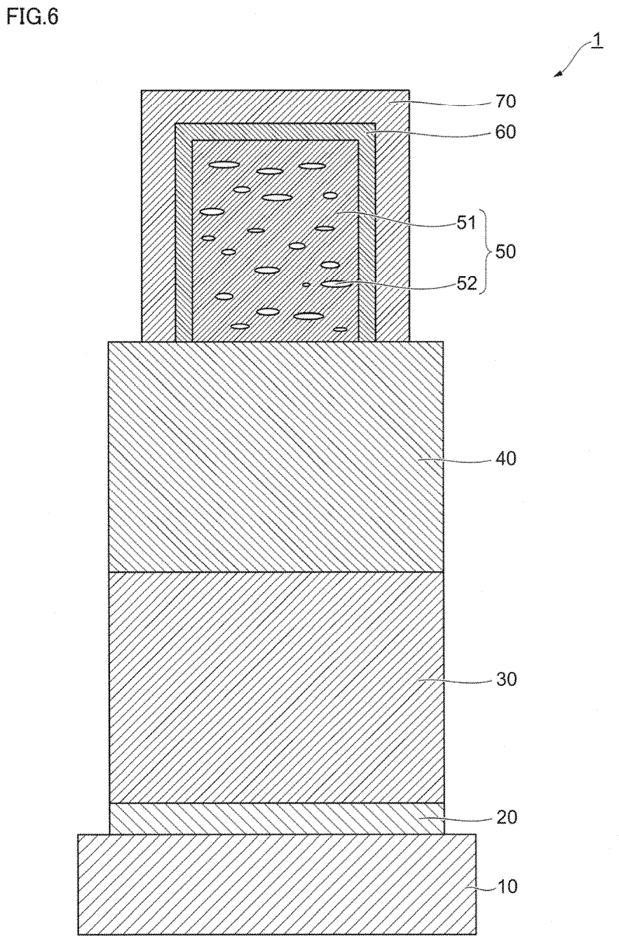

FIG. 6 shows a sectional structure of the lithium-ion rechargeable battery 1 of a first modification. FIG. 6 shows the lithium-ion rechargeable battery 1 after the initial discharge, namely after completion of its structure (corresponding to FIG. 1).

The first modification differs from the above embodiment in that, when viewed from above in FIG. 6, the plane size of the positive electrode collector layer 20 and the positive electrode layer 30 is almost equal to the plane size of the solid electrolyte layer 40. In the first modification too, the storage layer 50 of the lithium-ion rechargeable battery 1 can be made porous (see FIG. 6); this can be done by, in the same procedure as in the above embodiment (see FIG. 2), first manufacturing the lithium-ion rechargeable battery 1 containing the dense storage layer 50 and then subjecting it to the initial charge and discharge following the film deposition.

### (Second Modification)

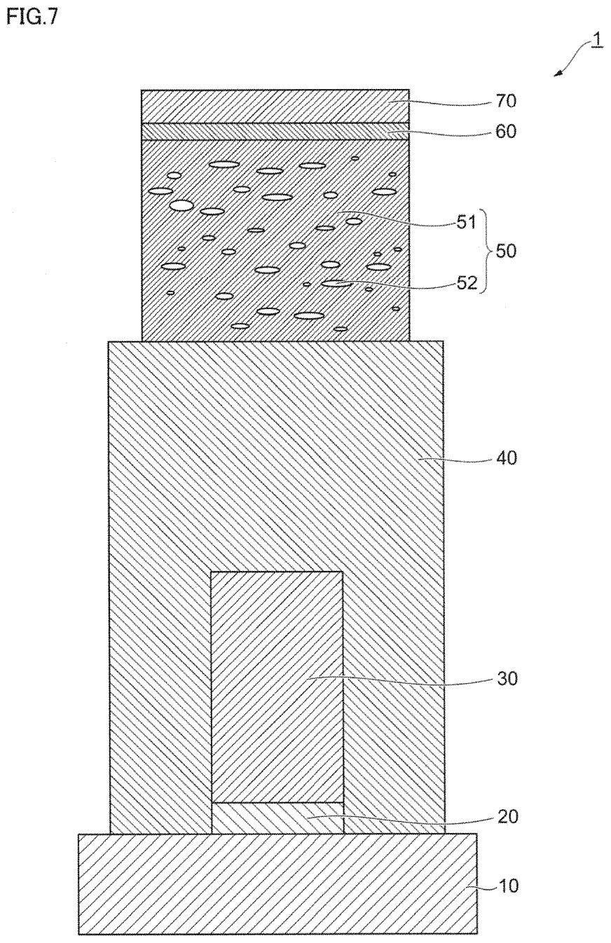

FIG. 7 shows a sectional structure of the lithium-ion rechargeable battery 1 of a second modification. FIG. 7 shows the lithium-ion rechargeable battery 1 after the initial discharge, namely after completion of its structure (corresponding to FIG. 1).

The second modification differs from the above embodiment in that, when viewed from above in FIG. 7, the plane size of the coating layer 60 is equal to the plane size of the storage layer 50, and also the plane size of the negative electrode collector layer 70 is equal to the plane size of the coating layer 60. In the second modification too, the storage layer 50 of the lithium-ion rechargeable battery 1 can be made porous (see FIG. 7); this can be done by, in the same procedure as in the above embodiment (see FIG. 2), first manufacturing the lithium-ion rechargeable battery 1 containing the dense storage layer 50 and then subjecting it to the initial charge and discharge following the film deposition.

### (Third Modification)

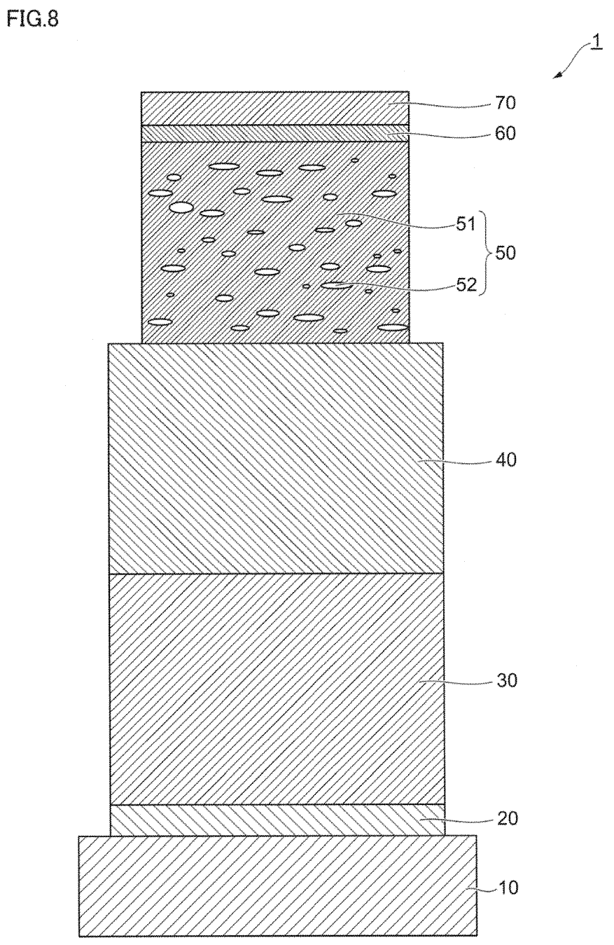

FIG. 8 shows a sectional structure of the lithium-ion rechargeable battery 1 of a third modification. FIG. 8 shows the lithium-ion rechargeable battery 1 after the initial discharge, namely after completion of its structure (corresponding to FIG. 1).

The third modification differs from the first modification in that, when viewed from above in FIG. 8, the plane size of the coating layer 60 is equal to the plane size of the storage layer 50, and also the plane size of the negative electrode collector layer 70 is equal to the plane size of the coating layer 60. In the third modification too, the storage layer 50 of the lithium-ion rechargeable battery 1 can be made porous (see FIG. 8); this can be done by, in the same procedure as in the above embodiment (see FIG. 2), first manufacturing the lithium-ion rechargeable battery 1 containing the dense storage layer 50 and then subjecting it to the initial charge and discharge following the film deposition.

### (Fourth Modification)

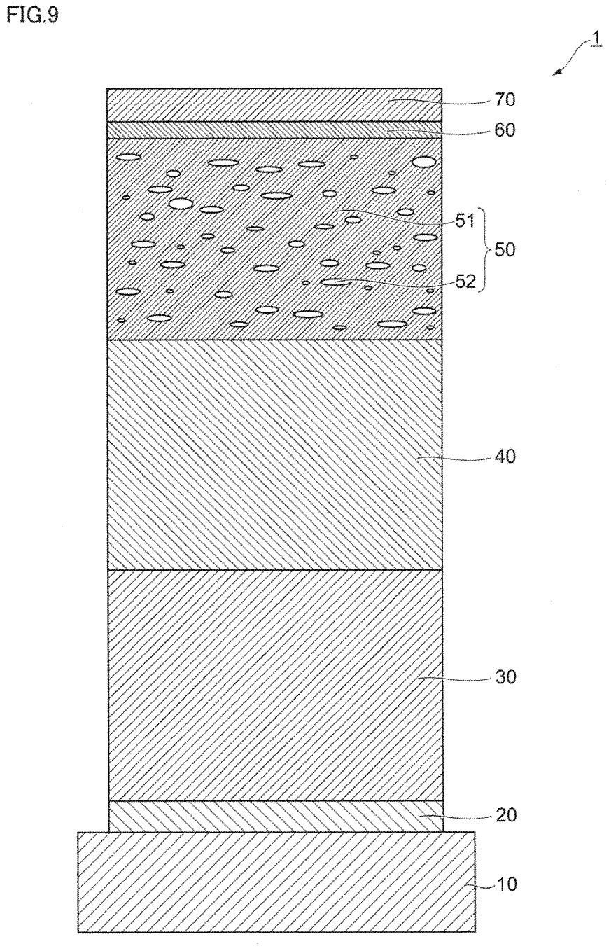

FIG. 9 shows a sectional structure of the lithium-ion rechargeable battery 1 of a fourth modification. FIG. 9 shows the lithium-ion rechargeable battery 1 after the initial discharge, namely after completion of its structure (corresponding to FIG. 1).

The fourth modification differs from the third modification in that, when viewed from above in FIG. 9, the plane size of the storage layer 50 is equal to the plane size of the solid electrolyte layer 40. In the fourth modification too, the storage layer 50 of the lithium-ion rechargeable battery 1 can be made porous (see FIG. 9); this can be done by, in the same procedure as in the above embodiment (see FIG. 2), first manufacturing the lithium-ion rechargeable battery 1 containing the dense storage layer 50 and then subjecting it to the initial charge and discharge following the film deposition.

### <Other Notes>

In the present embodiment, the storage layer 50 and the negative electrode collector layer 70 are made of the same noble metal (Pt); however, they may be made of different noble metals.

In the present embodiment, the basic structure of the lithium-ion rechargeable battery 1 is formed by stacking the positive electrode collector layer 20, the positive electrode layer 30, the solid electrolyte layer 40, the storage layer 50, the coating layer 60, and the negative electrode collector layer 70 in this order on the substrate 10. In other words, the positive electrode layer 30 is located closer to the substrate 10 and the storage layer 50 is located farther from the substrate 10. The present invention is, however, not limited to this structure. The storage layer 50 may be located closer to the substrate 10 and the positive electrode layer 30 may be located farther from the substrate 10; in this case, the order of stack of the layers is reversed from the way they are stacked in the above embodiment.

### REFERENCE SIGNS LIST

1 Lithium-ion rechargeable battery
10 Substrate
20 Positive electrode collector layer
30 Positive electrode layer
40 Solid electrolyte layer
50 Storage layer
51 Porous part
52 Pore
60 Coating layer
70 Negative electrode collector layer

1. A lithium-ion rechargeable battery comprising, in the following order:
a positive electrode layer containing a positive electrode active material;
a solid electrolyte layer containing an inorganic solid electrolyte having lithium ion conductivity; and
a porous noble metal layer having a porous structure and made of a platinum group element (Ru, Rh, Pd, Os, Ir, or Pt), gold (Au), or an alloy of some of the platinum group elements or at least one of the platinum group elements and the gold.

2. The lithium-ion rechargeable battery according to claim 1, further comprising an amorphous metal layer laminated on the porous noble metal layer, the amorphous metal layer having an amorphous structure and being made of a metal or an alloy.

3. The lithium-ion rechargeable battery according to claim 2, wherein the amorphous metal layer contains chromium (Cr).

4. The lithium-ion rechargeable battery according to claim 3, wherein the amorphous metal layer is made of an alloy of chromium (Cr) and titanium (Ti).

5. The lithium-ion rechargeable battery according to claim 2, further comprising another noble metal layer laminated on the amorphous metal layer, the another noble metal layer being made of a platinum group element (Ru, Rh, Pd, Os, Ir, or Pt), gold (Au), or an alloy of some of the platinum group elements or at least one of the platinum group elements and the gold.

6. The lithium-ion rechargeable battery according to claim 1, wherein the inorganic solid electrolyte in the solid electrolyte layer contains phosphate (PO₄³⁻).

7. The lithium-ion rechargeable battery according to claim 2, wherein the inorganic solid electrolyte in the solid electrolyte layer contains phosphate (PO₄³⁻).

8. The lithium-ion rechargeable battery according to claim 3, wherein the inorganic solid electrolyte in the solid electrolyte layer contains phosphate (PO₄³⁻).

9. The lithium-ion rechargeable battery according to claim 4, wherein the inorganic solid electrolyte in the solid electrolyte layer contains phosphate (PO₄³⁻).

10. The lithium-ion rechargeable battery according to claim 5, wherein the inorganic solid electrolyte in the solid electrolyte layer contains phosphate (PO₄³⁻).
